(19) United States
(12) Patent Application Publication
(10) Pub. No.: US 2026/0311670 A1
(43) Pub. Date: Oct. 8, 2026

(54) Elliptical Transducers

(71) Applicant: Qortek, Inc., Linden, PA (US)

(72) Inventors: Safakcan Tuncdemir, Linder, PA (US); Joshua Gambal, Linden, PA (US); Gareth Knowles, Linden, PA (US)

(73) Assignee: Qortek, Inc., Linden, PA (US)

(21) Appl. No.: 19/707,902

(22) Filed: Jun. 15, 2026

Related U.S. Application Data
(62) Division of application No. 17/911,945, filed on Mar. 16, 2021, now Pat. No. 12,658,168.
(60) Provisional application No. 62/990,377, filed on Mar. 16, 2020.

(51) Int. Cl. G10K 9/12; G10K 9/22; H04R 1/22

(52) U.S. Cl. CPC G10K 9/121; G10K 9/22; H04R 1/22

(57) ABSTRACT

An elliptical flextensional transducer is provided that includes a first platen of semi-wave geometry, the first platen has a positive semi-wave angle and a generally flat rim. A first sidewall assembly including a stacked ring and sidewall is stacked with the first platen. A second sidewall assembly including a stacked ring and sidewall is provided. A transductive element is disposed between and captured by the rings of the first and second sidewall and the second sidewall assembly is stacked with the first sidewall assembly. A second platen of semi-wave geometry is provided which has a positive semi-wave angle and a generally flat rim. The second platen is stacked with the second sidewall assembly.

This application is a divisional of U.S. application Ser. No. 17/911,945, filed Sep. 15, 2022, which was the National Stage of International Application No. PCT/US 2021/022632, filed Mar. 16, 2021, which claims the benefit of U.S. Provisional Patent Application Ser. No. 62/990,377 filed on Mar. 16, 2020, all of which are incorporated by reference herein in its entirety.

### STATEMENT REGARDING FEDERALLY SPONSORED RESEARCH OR DEVELOPMENT

This invention was made with government support under US Government Small Business Technology Transfer (SBIR) Contract: N68335-18-C-0477 awarded by The United States Navy. The government has certain rights in the invention.

### FIELD OF THE INVENTION

This invention relates to low frequency transducers that operate at high hydrostatic pressures.

### BACKGROUND OF THE INVENTION

Flextensional transducers have been used as underwater transducers since the 1950s and the US Navy presently fields such devices as acoustic countermeasures to deter and counter both enemy sonar systems and torpedoes. Such transducers comprise of a transductive assembly such as those based on piezoelectric or magnetostrictive drive element and a mechanical shell structure that clamps these element(s). The shell acts as a mechanical transformer which transforms the high impedance, small extensional motion of the transductive assembly into low impedance, large flexural motion of the shell. According to the shape of the shell, such transducer assemblies of prior art are divided into seven classes—Class I-Class VII.

In particular, low frequency transducers having resonances below about 1 KHz-10 kHz have numerous applications as low frequency sonar projectors. The acoustic wavelength corresponding to these frequencies is on the order of the size of naval mines, and thus can hunt for and/or classify them, as well as objects of similar size. Also, wavelengths of this size permit sonar location of buried objects, a task of interest to a wide range of commercial and governmental concerns. A large problem is that the designs of these transducer classes do not exhibit stable performance as hydrostatic pressure is applied. Transducers of prior art operate at increasing depths. The increasing hydrostatic pressure causes large variations in critical sonar metrics of Free-Field Voltage Sensitivity (FFVS) and Transmitting Voltage Response (TVR).

A further challenge is that of operating at lower sub kHz frequencies, especially at greater depths. Ability to operate transducers at lower frequencies enables longer range communication. Compact sized underwater transducers are becoming essential to deployed unmanned submersibles. In particular, there is large interest to enhance the range of underwater communication capability to beyond 10 km by employment of a compact, i.e., <4 inches, high-power underwater transducers that can be operated at depths below 400 ft. Of special note is compact communication needs for underwater drones, small UUAVs, and unmanned submarines. Such submersibles are also of interest in detecting objects in littoral environments for which small, unmanned submersible vehicles are best-suited due to volumetric constraints. This leads to a demand for sonar transducers that are compact but able to operate at lower depths, and that can communicate over longer ranges at such depths.

Conventionally, the only means to achieve longer range communication (lower operational frequency) is to increase the overall mass of the transducer employed or design a complex mechanical structure incorporating a plurality of transductive elements. Such existing transducer designs that are capable of generating sufficient acoustic power at frequencies under 30 kHz include free-flooded piezoelectric ceramic rings, electromagnetic and hydraulic drivers, tonpilz or piston transducers, and some flextensional devices. However, increasing size/weight often runs counter to modern advances in underwater system that are generally seeking more compact platforms introducing increasingly limited volumes for transducer or projector install, especially for applications where the transducer forms part of a hull protrusion.

Prior art Class-V transducers, such as those shown in FIG. 1, have proven their capability of providing very high figure of merit of acoustic radiation at low frequencies, attaining high Transmitting Voltage Response (TVR) in compact forms in the range of 55-60 watts/kHz kg as to represent the highest figure of merit across all said seven classes of flextensional transducers used in underwater applications. Importantly, due to their stiffer drive structure as compared to other classes of transducer, Class-V (Cymbal) transducers can withstand greater stress so the present solution is to employ Class-V transducers for acoustic projectors at depth. However, there is a fundamental problem with Class-V transducers in that, at present, these cannot operate at greater depths, e.g., depths of greater than about 200 ft. (61 meters). At such depths static water pressures will cause the top and bottom conical platens to collapse and impinge onto the transversal transductive assembly. For example, a 3-inch diameter Class-V transducer will experience sufficient deformation even at 200 ft (61 meters) in normal salinity and temperature conditions as to cause said top and bottom platens to collapse onto the transductive assembly, making them non-operational as an acoustic projector when approaching pressures at such depths.

Class VI and Class VII flextensional transducers were introduced as a means of overcoming the limitation of transducers at greater depths. Class VII transducers are made from shells shaped like a dog bone and, consequently, are known as dog-bone shell transducers. Both classes essentially invert their outer shells as to present a convex structure as opposed to the convex structure of Class-V transducers. Such classes of transducer advantageously produce circumferential pressure on the outer connector ring with increasing ambient pressure.

Known underwater transducers do not achieve low frequency acoustical behavior when exposed to elevated hydrostatic pressure without addition of significant mass and shell (housing) volume. The optimal configuration for ring transducer designs to resist hydrostatic pressure is to design the shell to an approximate annular (for planar transducers) or spherical (for ring transducers) shape. However, this introduces unacceptable size and weight penalties for use in many smaller deep-water operating submersibles. U.S. Pat. No. 6,643,222 B2 introduces a planar transducer that may be considered equally as a modified Class IV or Class VII transducer where the oval shell has a planar ‘concave-convex’ geometry as to purportedly provide higher resistance to hydrostatic pressure without resorting to a large spherical geometry. The problem it introduces is its ‘continuous wave’ profile incorporates heavy convex bulbous ends (element [110] of FIG. 2) to allow a substantially constant stress on said transduction assembly over a broad range of depths. The purpose of which is enable the transducer to operate at shallow depths prior to the increasing circumferential pressure induced stress occurring at depth. Thus, the design described in the '222 patent is neither compact nor lightweight making it unsuitable for incorporation into smaller deep water operating submersibles. Moreover, it is limited in depth of operation (ambient pressure) to whatever the pre-set compression formed on transduction driver 30 by shell 200 during assembly.

U.S. Pat. No. 6,798,122 B1 discloses a projection array comprising transducers of ring-type, in this case Class V, transducers. However, the prior art recognizes challenges in achieving such a projector array of ring-type transducers. Arrays of ring transducers require adding threaded posts (element 10 shown in FIG. 3) welded to the apex (centroid) of the top portion of the top platen of each transducer element as to provide mechanical connection points (elements 16A and 20A shown in FIG. 3) rigidly connecting adjacent transducers; similarly repeated for the bottom platen of each ring transducer shell. These threaded posts now also act as the means for positive and negative polarity connections of the transductive element, typically a piezoceramic disc wherein a washer and nut are used to mechanically affix flexible copper electrical conductor strips.

What is needed is a transducer capable of operating at elevated hydrostatic pressures in a compact lightweight design suitable for small deep water operating submersibles. What is further needed is a transducer array assembly that eliminates the use of individual connectors for each transducer.

### III. SUMMARY OF INVENTION DISCLOSED

An elliptical flextensional transducer is provided that includes a first platen of semi-wave geometry, the first platen has a positive semi-wave angle and a generally flat rim. A first sidewall assembly including a stacked ring and sidewall is stacked with the first platen. A second sidewall assembly including a stacked ring and sidewall is provided. A transductive element is disposed between and captured by the rings of the first and second sidewall and the second sidewall assembly is stacked with the first sidewall assembly. A second platen of semi-wave geometry is provided which has a positive semi-wave angle and a generally flat rim. The second platen is stacked with the second sidewall assembly.

### VI BRIEF DESCRIPTION OF THE DRAWINGS

The present invention is described with reference to the accompanying drawings. In the drawings, like reference numbers indicate identical or functionally similar elements. The use of cross-hatching and shading within the drawings is not intended as limiting the type of materials that may be used to manufacture the invention.

FIG. 1 depicts a prior art Class-V acoustic projector.

FIG. 2 shows a prior art continuous wave Class-VII acoustic projector having bulbous ends.

FIG. 3A illustrates a top view of a prior art acoustic projector array comprised of Class-V transducers.

FIG. 3B illustrates sectional view of the acoustic projector array of FIG. 3A.

FIG. 4A shows a perspective view of a flextensional transducer in accordance with an embodiment of the invention.

FIG. 4B illustrates a sectional view of the flextensional transducer of FIG. 4A.

FIG. 5A depicts a cut-away view of a flextensional transducer in accordance with an embodiment of the invention.

FIG. 5B shows a sectional view of the flextensional transducer of FIG. 5A.

FIG. 6 depicts an exploded view of a platen taken from box AA of FIG. 4B.

FIG. 7 shows an exploded view of a flextensional transducer in accordance with an embodiment of the invention.

FIG. 8A illustrates a top view of a transducer array in accordance with an embodiment of the invention.

FIG. 8B is a sectional view of the transducer array taken along line DD of FIG. 8A.

FIG. 9A is a is a plot showing a performance comparison of a semi-wave modular Class-VIII transducer of the present invention and a bulbous ring-versioned Class-V transducer.

FIG. 9B is a sectional view of bulbous ring-versioned Class-V transducer.

FIG. 9C is a sectional view of a Class-VIII transducer in accordance with an embodiment of the invention.

FIG. 10 is a plot showing the TVR versus frequency performance of the transducers of FIGS. 4A and 4B and of FIGS. 5A and 5B.

FIG. 11A shows platen deformations of Class-V cymbal transducers when applying hydrostatic pressures.

FIG. 11B depicts platen deformations of Class-VIII jinc transducers when applying hydrostatic pressures.

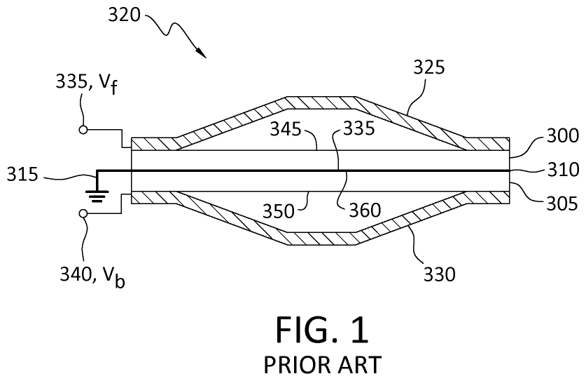

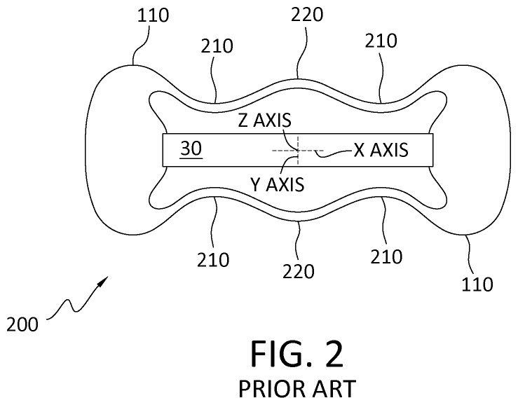

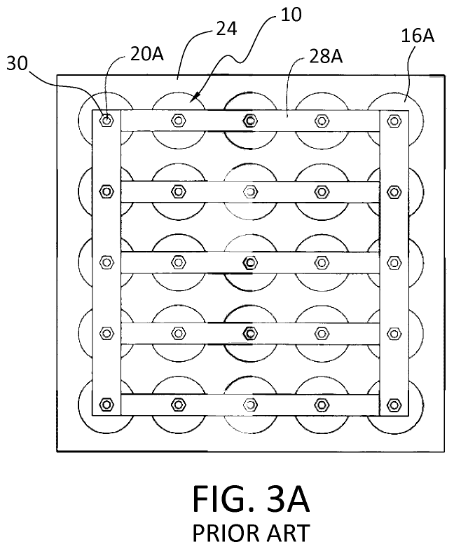

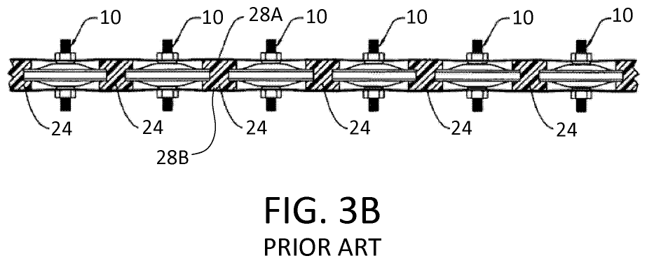

### VII DESCRIPTION OF THE EMBODIMENTS

The present invention is generally directed to a semi-wave spherical transducer that comprises a circular or elliptic transduction assembly (shell) that has sidewalls captured between identical opposing circular or elliptic conical segments (platens), each having a surface geometry of a radially symmetric wave shape that includes a center region having a center region and a rim wherein the distance between the upper and lower center regions center region is strictly greater than the distance between the upper and lower rims. Typically, any radial undulation line-cut of the semi-wave platen geometry identically terminates at a small annular region at the rim and a small disc region of radius greater or equal to zero centered at its apex that is generally flat. The undulation path of each radial cut of the platen is of a (wave) geometry introducing local maxima and minima, for the corresponding platen to be considered semi-wave, these isomorphic undulation paths must meet certain geometric requirements: (i) taken from the rim each undulation first forms a local minima (a first inward undulation), (ii) the local maxima of each undulation path are strictly increasing from the rim to apex, (iii) the semi-wave angle, defined as this positive slope of the conical segment as taken between the rim and the central axis in reference its radial axis, must be strictly positive.

The overall curvature design of the shell is designed in such a manner that it induces a negative Poisson ratio on the overall transducer shell assembly, improves the TVR, and decreases its effective frequency band over all such 2D or 3D shell structures of prior art. In some embodiments, the undulation pattern and flat regions comprising the conical shell surface geometry are developed using 3D modeling algorithms as to ensure negative Poisson's ratio behavior.

Embodiments of a Class-VIII transducer may exhibit by one or more of the following characteristics. First, the transducer may have identical top and bottom platen that are uniformly radial and not planar. Second, the platens may possess a uniform semi-wave geometry, that is, any radial cut from any edge point to the center of a platen forms a semi-wave function independent of selection of edge point. Third, the maximum height of each platen occurs, at or near, its center point is significantly higher than any point on the rim of said platen, i.e., having a strictly positive semi-wave angle. Fourth the undulation geometry of the platens is made to be generally horizontally flat over a small region around its center point and generally is made to be horizontally flat over a small region around its circumference. A transductive element in the form of a disc or disc assembly is captured between the upper and lower platen. The transductive element may include monolithic or multilayer piezoceramic discs, magnetostrictive discs, or combinations thereof where laminates and parts are suitably electroded.

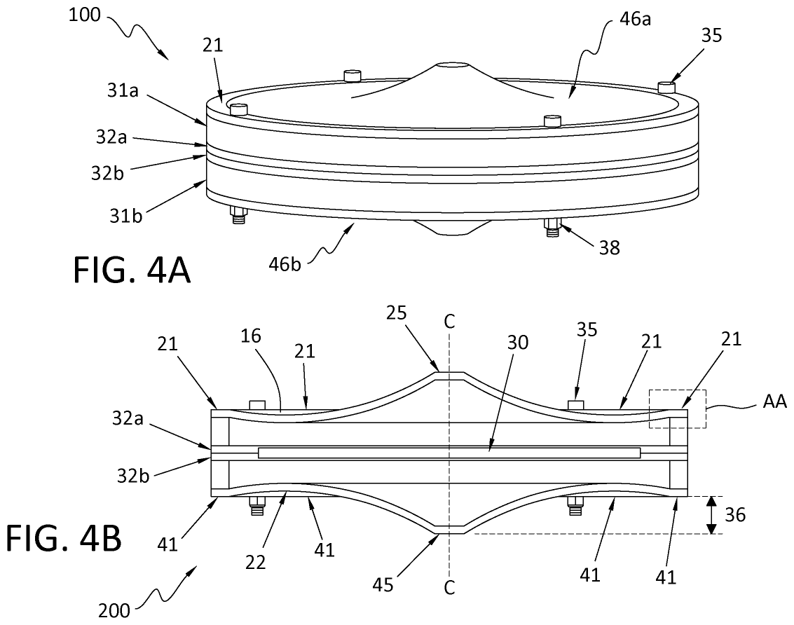

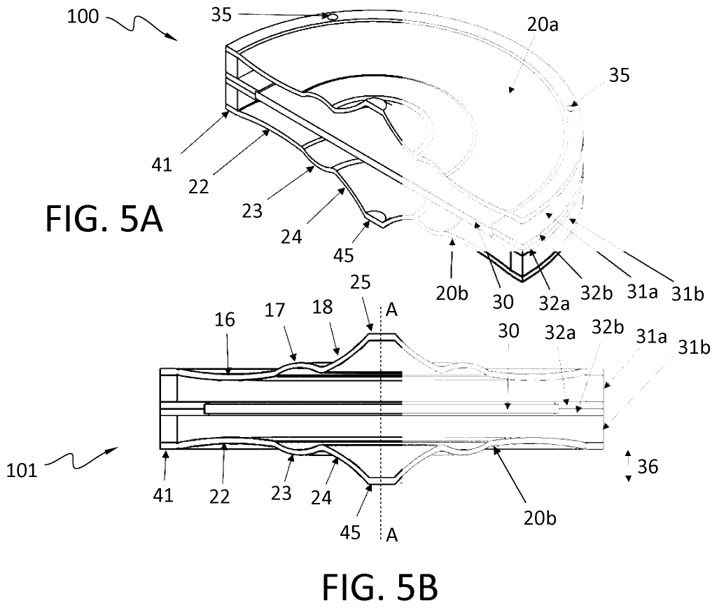

Examples of Class-VIII transducer platen undulation geometry include the jinc function, sometimes called a besinc function, shown in FIGS. 4A and 4B, or a recurve function illustrated in FIGS. 5A and 5B. A counterexample to an undulation function is a sinc function for, unlike a sinc function, the zeroes of a jinc function are not periodically spaced, which is critical to this new class of transducers. The platen geometry of the embodiment of the invention depicted in FIGS. 4A and 4B is the stationary shape of the fourth mode of a clamped circular membrane that is then horizontally flattened over a small region around its center and at its circumference. Other examples of undulation platen geometry can include the sombrero function and other such non-uniform zero-crossing wave functions having a positive semi-wave angle.

Turning to the drawings, FIG. 4A and FIG. 4B depict a Class-VIII transducer 200 in accordance with an embodiment of the invention. Transducer 200 includes identical top and bottom radial or elliptic isomorphic platens 46a and 46b that are of overall strictly increasing undulation but are locally strictly decreasing at the rims. Platens 46a and 46b display a jinc-type undulation geometry, i.e., a geometry that is described by a jinc function along the surface between any radial edge point and a maximum height center point. That is each platen undulates in a circular or elliptic pattern toward its apex (25 top 45 bottom) centered about a central axis illustrated as line C-C. In keeping with an aspect of the invention, the local radial maxima of the undulations strictly increase providing each platen with a strictly positive slope from an edge of generally flat outer rim 21 to generally flat apex region 25. The first inward undulations 16 (top) and 22 (bottom) have a local radial minima that is strictly below, or above, a generally flat outer rim 21 and 41 of platens 46a and 46b respectively. These flat outer rims 21 and 41 are separated by a top and bottom sidewalls 31a and 31b respectively that are configured in a manner as to capture a transverse circular or elliptic transductive element 30. Platens 46a and 46b have a generally flat apex region 25 and 45, respectively centered at central axis C-C. Sidewalls 31a and 31b capture thin notched outer rings 32a and 32b by a set of vertical thru-connectors 35 and a matching set of locking mechanisms 38. Notched rings 32a and 32b, fabricated of non-conductive material, in turn capture a transversal transductive element 30 as to create a rigid shell that intimately holds transductive element 30 in a transversal fashion across the middle of the shell.

In keeping with the invention, as illustrated in FIG. 5A and FIG. 5B respectively, such undulated platens 20a and 20b may have a variety of geometries provided that the platens are of strictly increasing undulation that are locally strictly decreasing at the rims leading to a positive vertical distance 36 between the generally flat rims 21 and 41 and the generally flat apex region 25 and 45 respectively centered at a central axis depicted as line A-A. Specifically, FIGS. 5A and 5B depict platens of having a semi-wave or undulation geometry of the recurve type. That is, a geometry described by a recurve function along a surface between any radial edge point and the maximum height center point of either top or bottom platen. The embodiment of FIG. 5A and FIG. 5B has multiple undulations 22-16-23-17-24-18 of strictly increasing local maxima 21-17-25.

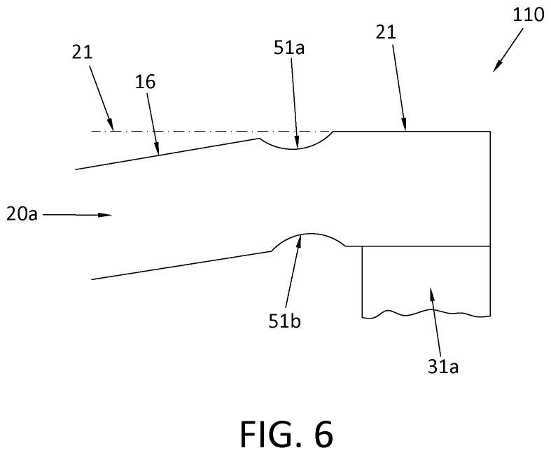

FIG. 6 is an exploded view of the radial edge of platen 46a and rim 21. In this embodiment each top and bottom platens 46a and 46b may incorporate hinge points 51a and 51b obtained by uniformly excising platen material of the first inward undulation region 16 of top platen and first undulation region 22 of bottom platen in a radial or elliptic pattern located at the top and/or bottom surface of the platen at a region abutting the flat outer ring region 21 or the sidewall 31a respectively. In some embodiments, further hinge points (not shown) can similarly be established by uniformly excising platen material at locations across said platens 46a and 46b in a similar radial or elliptic fashion.

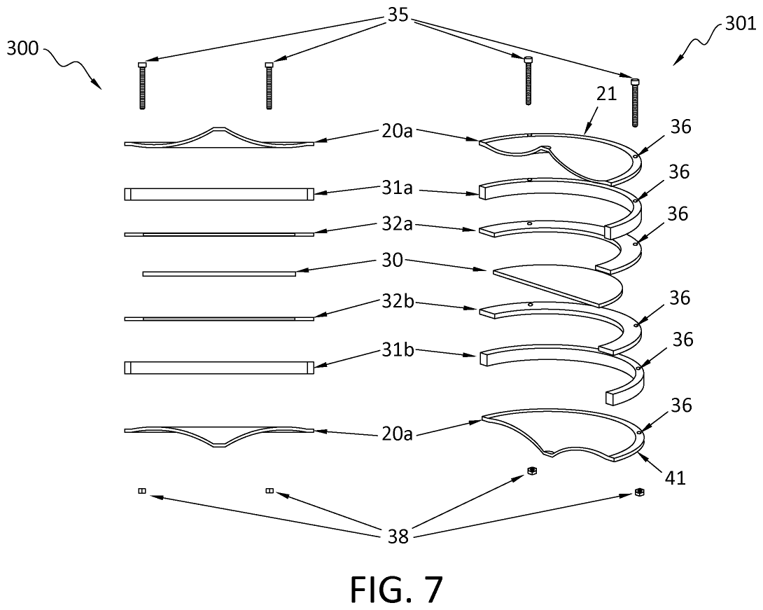

In accordance with yet another embodiment, FIG. 7 shows a modular assembly of a Class-VIII transducer. This modular construction embodiment includes top and bottom increasing undulation platens 20a and 20b as described that have a set of holes 36 located around a generally flat rim region 21 that are aligned with corresponding holes 36 in stacked interstitial separating elements of that successively comprise of outer sidewall 31a, notched non-conductive planar ring 32a, transduction element 30, notched non-conductive planar ring 32b, outer sidewall 31b, and terminating with bottom strictly increasing undulation platens 20b at generally flat region 41. The notched regions of thin planar rings 32a and 32b are configured to intimately capture transductive element 30 when pressed together. A corresponding set of thru-connectors 35 traverse holes 36 of each element of 300 in the order described as to terminate underneath flat region 41 of 20b. In some embodiments, thru-connectors 35 may be standard threaded thru-bolts. A washer nut assembly 38 is then employed at each thru-connector 35 and torque is applied to tighten each said assembly 38 as to rigidly and intimately capture all said elements of transducer 300. In some embodiments adhesives agents may be applied between each successive element of transducer 300 that may also be part of an additional potting process for transducer 300.

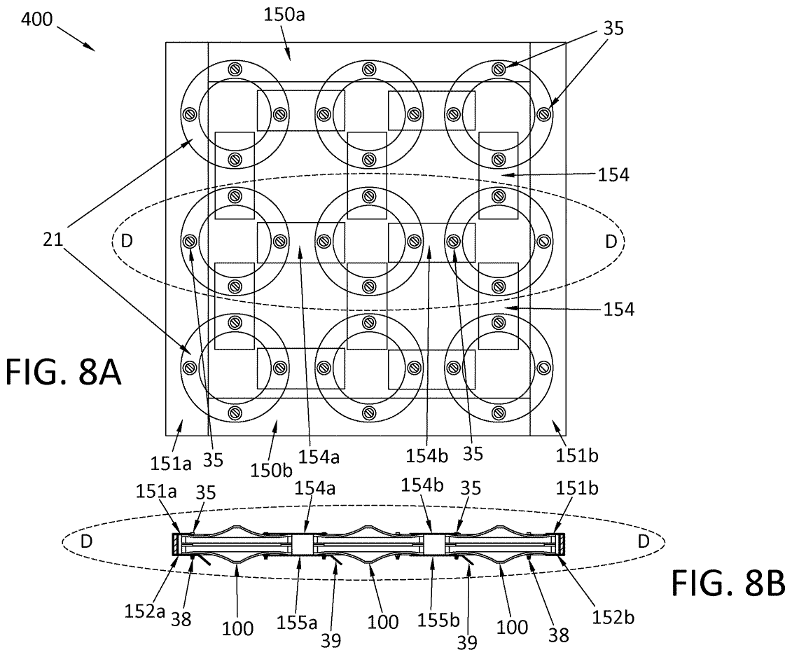

The modular construction of Class-VIII transducers is highly conducive to enabling a similarly non-bonded modular constructed transducer array. FIGS. 8A and 8B depict an embodiment of such an array. As shown, in some embodiments, thru-connectors 35 can be arranged in a quadratic arrangement aligned vertically and horizontally. With such an arrangement stiff top and bottom beams 150a and 150b may have thru holes that align with the upper and lower thru-connectors 35 respectively. Similarly, stiff left and right beams 151a and 151b may have thru holes that align with the leftmost and rightmost thru-connectors 35, respectively. Further vertical stiff cross-connector beams 154 with matching aligned thru-holes 35 and horizontal stiff cross-connector beams 154a with matching aligned thru-holes 35 vertically and horizontally connect adjacent modular Class-VIII transducers, respectively. An identical arrangement is applied to the underside of the transducer array 400 wherein similarly, stiff left and right beams 152a and 152b may have thru holes that align with the leftmost and rightmost thru-connectors 35, respectively. Vertical stiff cross-connector beams 155a with matching aligned thru-holes 35 and horizontal stiff cross-connector beams 155b with matching aligned thru-holes 35 vertically and horizontally connect adjacent modular Class-VIII transducers, respectively. A thru-connector 35 is inserted through each set of aligned thru-holes in the array. A washer nut assembly 38 is then employed at each thru-bolt 35 and torque is applied to tighten each nut assembly 38 as to rigidly and intimately secure all of the transducers of array 400.

In some embodiments, thru-connectors may be eliminated by laser bonding the assembly. In such embodiments the assembly is placed under load during the laser bonding process which facilitates capture the transversal transductive assembly by the upper and lower undulation platens.

Still other embodiments may incorporate small slots or holes into the undulation platen of as ports to introduce for fluidic filler, such as an oil, as a means of introducing passive hydrostatic pressure compensation. Such fluidic compensation will further broaden the range of operational hydrostatic pressures without significant decrease in performance or failure.

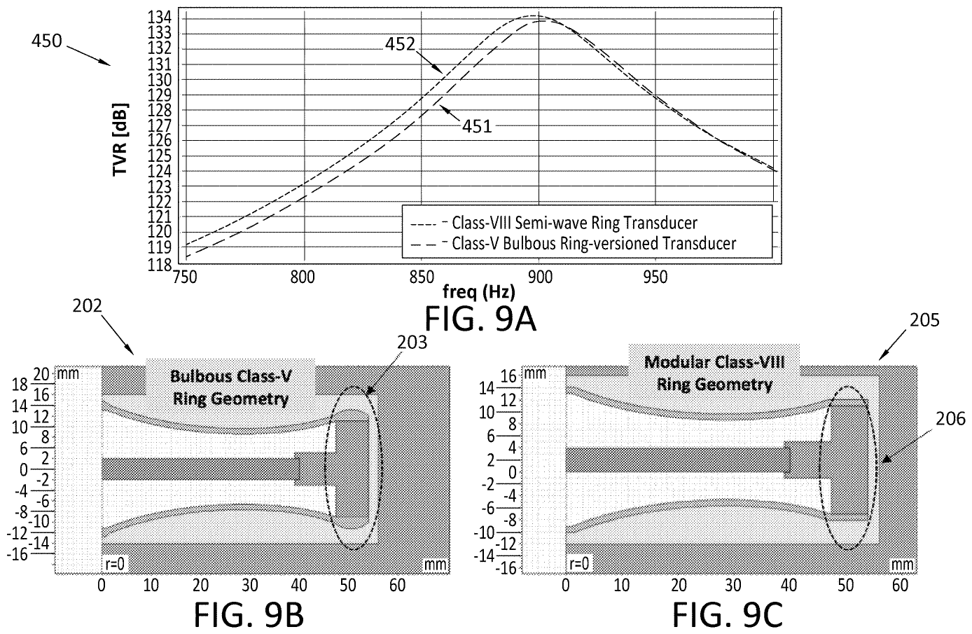

FIG. 9A is a plot showing a performance comparison of a semi-wave modular Class-VIII transducer 205 (FIG. 9C) of the present invention and a bulbous ring-versioned Class-V transducer 202 (FIG. 9B) that was obtained by rotating the Class IV transducer planar design described in U.S. Pat. No. 6,643,222 B2 circumferentially around its central axis as to produce a bulbous radial transducer 202. This results in the ring-versioned bulbous Class V transducer 202 having an annular bulbous sidewall 203 in contrast to the flat sidewall 206 of transducer 205. Plot 450 shows a comparison of transmitting voltage response (TVR) 452 for the transducer 205 and TVR 451 of the radial versioned planar bulbous design 202. Despite having considerably less weight, the TVR response 452 of transducer 205 is superior to that of Class V transducer 202. An additional advantage is that pressure models show that Class-VIII transducer 205 is far less limited in depth of operation (ambient pressure) than bulbous radial transducer 202.

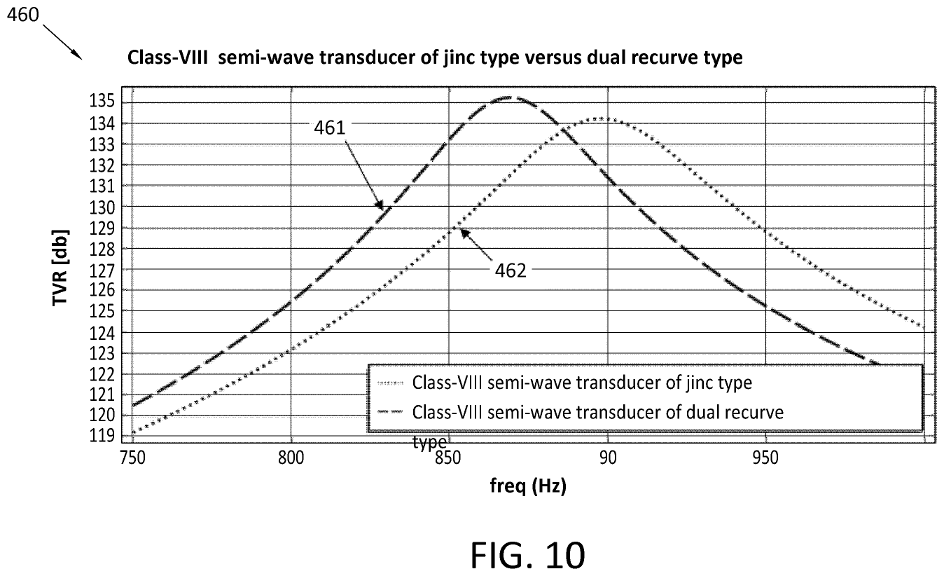

Referring to 460 of FIG. 10, shows the TVR versus frequency behavior comparison of a semi-wave transducers of this invention of jinc-type (see FIG. 4) and recurve type (see FIG. 5). That is, the transducers used to generate plot 460 are of equal sizing having the same planar diameter, same apex height 36, same sized sidewall configuration 31a, 32a, 32b, 31b and same transductive element 30 that, in this embodiment, is a piezoceramic disc. However, the transducers possess different platen undulation semi-wave geometries, one being jinc-type and one being recurve-type. The resulting TVR responses illustrate how differing undulation platen geometries lead to quite distinct TVR behavior in otherwise identical Class VIII transducers. In the embodiments shown, the TVR responses 461 and 462 show that a dual recurve Class VIII transducer will exhibit superior TVR response and operates over a lower frequency band than a jinc-function Class VIII transducer. However, the jinc-type transducer can operate to greater ambient pressures than the matching dual recurve-type. Plot 460 illustrates the trade between depth of operation TVR response and effective frequency band for differing type Class VIII transducer designs.

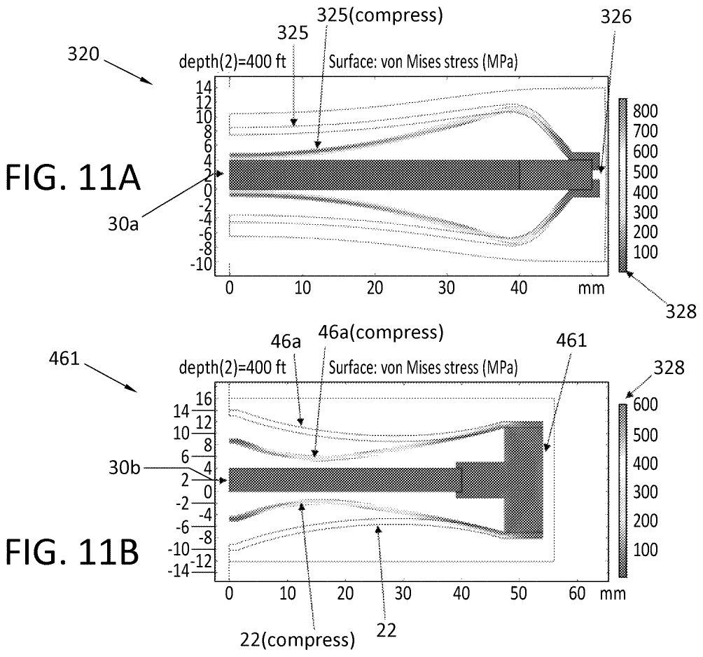

FIGS. 11A and 11B show platen deformations of Class-V cymbal and Class-VIII jinc transducers, respectively, when applying higher hydrostatic pressures. An identical sized Class-V cymbal transducer 320 and Class-VIII jinc-type transducer 461 have different sidewall arrangement. Cymbal transducer 320 employs the more standard sidewall 326 that captures disc piezoceramic 30a. Jinc-type transducer 461 employs a modular sidewall 462 to capture disc piezoceramic 30b. In this embodiment, disc piezoceramics 30a and 30b are of identical size and are made of the same material. As illustrated in FIG. 11A, as ambient pressure increases the platen 325 quickly collapses so as to impinge on the ceramic 30a thereby disabling piezoceramic 30a from functioning as a transducer. In contrast, as ambient pressure similarly increases on the Class-VIII jinc-type transducer 461 the platen 462 compresses at its first inward undulation 46a causing it to compress without impinging on the ceramic 30b. Platen 462 continues to not impinge on piezoceramic 30b until far greater pressure is applied than is needed to compress 325 onto the piezoceramic 30a. The result is that same sized Class-VIII radial transducers 461 can operate effectively to far greater depth than Class-V radial transducers, such as cymbal transducers, without providing significant additional mass into their platen designs.

It is believed that there are two underlying reasons to why the transducers of this invention exhibit high hydrostatic pressure stability. The first is that the undulation geometry of the platens mimic a more spheroidal implementation of the shell or housing of the disc transductive assembly, the second is that the undulation geometry is so designed as to impart a negative mechanical Poisson's ratio on the housing. The first better approximates the optimal design of a transducer housing for operating to greater depths without incurring the large overall sizing penalty, the second assures that the transductive assembly remains in compression as hydrostatic pressures increase. Correctly designed, these geometries also increase acoustic power projection capability per unit volume without resorting to heavy mass additions.

While the present invention has been illustrated by the description of specific embodiments thereof, and while the embodiments have been described in considerable detail, it is not intended to restrict or in any way limit the scope of the appended claims to such detail. The various features discussed herein may be used alone or in any combination. Additional advantages and modifications will readily appear to those skilled in the art. The invention in its broader aspects is therefore not limited to the specific details, representative apparatus and methods and illustrative examples shown and described. Accordingly, departures may be made from embodiments and examples herein described without departing from the scope or spirit of the general inventive concept.

The present invention may be employed in various systems and devices that require energy harvesters, actuators and/or sensors to operate in extreme conditions such as hypersonic vehicles, hypersonic weapons, re-entry vehicles, communication satellites, jet engines, industrial processes, space propulsion systems and other deep space devices. Further, the invention may be used in a variety of high temperature, high radiation sensor implementations including strain sensors, pressure sensors, gas sensors and accelerometers.

What is claimed is:

1. An elliptical flextensional transducer comprising:
a first platen of semi-wave geometry, having a positive semi-wave angle and a generally flat rim;
a first sidewall assembly including a stacked ring and sidewall, said first sidewall assembly being stacked with said first platen;
a second sidewall assembly including a stacked ring and sidewall;
a transductive element disposed between and captured by the rings of the first and second sidewall, said second sidewall assembly being stacked with said first sidewall assembly;
a second platen of semi-wave geometry, having a positive semi-wave angle and a generally flat rim, said second platen being stacked with said second sidewall assembly.

2. The elliptical flextensional transducer of claim 1 wherein the first and second platens include corrugated sections.

3. The elliptical flextensional transducer of claim 1 wherein each of the first and second platens has a central region that is generally flat.

4. The elliptical flextensional transducer of claim 1 wherein the rings of the first and second sidewall assemblies each include a notch region configured to capture said transductive element.

5. The elliptical flextensional transducer of claim 1 wherein the rim of said first platen, the ring and sidewall of said first sidewall assembly, the ring and sidewall of said second sidewall assembly and the rim of said second platen are connected by through connectors.

6. The elliptical flextensional transducer of claim 1 wherein the rim of said first platen, the ring and sidewall of said first sidewall assembly, the ring and sidewall of said second sidewall assembly and the rim of said second platen are adhered to one another with an adhesive agent.
